(19) United States
(12) Patent Application Publication
(10) Pub. No.: US 2002/0130768 A1
(43) Pub. Date: Sep. 19, 2002

(54) Low voltage power line carrier communications at fundamental working frequency

(76) Inventors: Hongyuan Che, Shenzhen (CN); Jimmy Guo, Shenzhen (CN); Benjamin Hu, (US); Jeong Hu, Summit, NJ (US)

Correspondence Address: LIU & LIU LLP, 811 WEST SEVENTH STREET, SUITE 1100, LOS ANGELES, CA, 90017, US

(21) Appl. No.: 09/905,328

(22) Filed: Jul. 13, 2001

Related U.S. Application Data
(60) Provisional application No. 60/275,784, filed on Mar. 14, 2001.

(51) Int. Cl. H04M 11/04

(52) U.S. Cl. 340/310.01; 340/310.06

(57) ABSTRACT

A two-way carrier wave digital data transmission between a terminal station and a central station over low-voltage power line with long distance of transmission and high accuracy at low implementation costs. Long distance of data transmission is achieved by generating a high-energy communication signal by shorting the circuit near the zero crossing of the fundamental power wave, where the attenuation effect on the carrier signal is least. High accuracy of data transmission is achieved by generating a carrier communication signal at low frequency with a triggering/interrupt voltage signal that is much higher than the expected random noise signal in order to have high signal-to-noise ratio at the fundamental working frequency. As a result of the high signal-to-noise ratio, the receiver then can receive the transmitted signal and clearly differentiate between a “1” bit and a “0” bit data.

This application is a continuation-in-part of earlier application No. 60/275,784, filed Mar. 14, 2001.

### BACKGROUND OF THE INVENTION

1. Field of the Invention

This invention relates generally to power line communication systems and more particularly to a method to provide two-way carrier wave digital data transmission between a terminal station and a central station over low-voltage power line utilizing the fundamental working frequency.

2. Background

In the United States, the standard source of electric power is the local electric power company, which generates and/or distributes 60 Hz alternating current (AC) power to the residential, commercial, and industrial customers. As shown in FIG. 1, three-phase power is generated and transformed to high voltage at generating station 110, and transmitted to receiving stations 120, and on to distribution station 130 where the power is transformed from high voltage to medium voltage. Three-phase power is further distributed via primary feeder 140 to single-phase distribution transformer 150, where the medium voltage power is transformed to low voltage power for final distribution to the customer via the service meter panel 200.

The distribution voltages at the customers' service level can be 120/240 VAC, single-phase power; 120/240 VAC three-phase power; 120/208 VAC, three-phase power; and 277/480 VAC, three-phase power; or any of the variations. In the 277/480 VAC notation, the first value 277 VAC is the line-to-neutral voltage, while the second value 480 VAC is the line-to-line voltage. The supplied voltage level is dependent on the type of service requested based upon the electrical loads and the available distribution voltage. Likewise, power meter to be installed at the service meter panel can be selected accordingly to measure power consumption for any of the distribution voltages, single-phase or three-phase.

For most residential customers, as shown in FIG. 2, the service feed is 120/240 VAC, single phase, three wires, from the distribution transformer 150 to the meter service panel 200. The electrical service feed consists of three wires: two hot wires 160 and 170; and one neutral wire 180. The voltages between hot wire 160 and neutral wire 180, and between hot wire 160 and neutral wire 180 are 120 VAC. The voltage between hot wire 160 and hot wire 170 is 240 VAC. The multi-voltage service feed is required to supply power to equipment with varying power requirements, with load 280 with large power requirement such as an electric oven being fed from the double pole 240 VAC branch circuit breaker 230. For load 290, with smaller power requirement such as a receptacle to feed a lamp, the power is fed from a single pole 120 VAC branch circuit breaker 240.

The meter service panel 200 also has a watthour meter 210 to measure total consumed power, and a main circuit breaker 220 to disconnect all of the electrical loads to the customer. In the presentation of this invention, the meter service panel 200 with voltage level of 120/240 VAC, single phase will be used for illustration.

Usually, the local power utility services the surrounding geographical area. It installs and maintains the distribution equipment and service wires up to the meter service panel 200. Within the customer's property, the customer is responsible for the internal distribution system. Further voltage transformation may be required within the customer's property to address other electrical loads at lower voltages.

Since electrical power is widely distributed throughout the United States, it's advantageous to utilize the electrical distribution power network as a communications medium. This approach of utilizing existing infrastructure is usually simpler and more economical than obtaining the right of way and developing and building a new dedicated communications system. Power line carrier technology has been developed in the past to take advantage of this available infrastructure. However, due to the difficulties listed below, the technology has not been widely used as a preferred mode of low speed communications where high accuracy is a major concern.

Existing Technology

The elements of prior art carrier channel are the sending terminal assembly including sending station coupling and terminal assembly, line matching and tuning, receiving station coupling and terminal assembly, numerous filters, and the power line.

Numerous modulation methods are available for PLC digital transmission. They operate at frequencies much higher than the fundamental frequency. The more popular methods of modulations are Frequency Shift Keying (FSK), and Frequency Hopping.

Frequency Shift Keying modulation is a form of modulation where the frequency of the carrier wave is varied by the binary input stream. As shown in FIG. 3, as the binary input signal 310 changes from a logic “1” to a logic “0”, and vice-versa, the frequency modulator 330 shifts the input sine wave carrier 320 between two frequencies: a mark or logic “1” frequency and a space, or logic “0” frequency as indicated in output waveform 340.

FSK is widely used for power line communications. However, as a result of low resistance to interferences from power line, the error rate maybe too high for use in applications, which require high accuracy such as remote equipment control and load shedding.

Another method, which can be used in conjunction with FSK, is the utilization of multiple frequency modes. The main goal is to be frequency agile and to avoid noise when it is encountered. When the communication system encounters noise at a certain bandwidth, it skips to a different bandwidth, moving away from the original interference. The receiver knows which frequency to use for demodulation via handshaking routines that occur between transmitter and receiver, overseen by the host processor. Upon startup, the receiver enters a system acquisition routine, searching the available system bands for a transmission signal. Once acquired the receiver and transmitter communicate as to when to shift operation band when it's determined that the measured error rate has risen above a certain threshold.

However, as indicated by the necessary steps to sidestep frequencies where noise, random or repetitive, occurs, the circuit can be more complex to implement, thus increasing the cost of the device. The bandwidth for communications is also larger to accommodate frequencies for hopping.

Design Considerations

Power lines and their associated networks are not designed for communications use. The major problem to be resolved is noise, or interference, which can be defined as undesirable electrical signals that distort or interfere with the original or desired signal. There are three dominant types of interference: periodic pulse, periodic/invariant time and random, usually. Examples of noise sources include thermal noise due to electron movement within the electrical circuits, electromagnetic interference due to electric and magnetic fluxes, and other transients that are often unpredictable. Noise injected on the lines includes fixed frequency noise resulting, for example, from the switching of inductive loads. Other noise arises at harmonics of the frequency of the network. Therefore, it's assumed that noise at the receiver is unknown to the transmitter. A noise source anywhere between the transmitter and the receiver could decrease the signal to noise ratio below the tolerance level, thus yielding erroneous received data.

The signal attenuation on low-voltage power line is dependent on the distance of transmission and the size of the electrical load. When there is little load on the power line, point-to-point carrier signal can be transmitted further in term of kilometers; and when the power line is overloaded, the signal can only be transmitted for dozens of meters. Factors that cause the attenuation on power line include line self-induction, parallel load connection load, and phase coupling loss. In general, the attenuation on power line increases with frequency.

The ratio of the signal voltage to the noise voltage determines the strength of the signal in relation to the noise. This is called signal-to-noise ratio (SNR) and is important in assessing how well the signal is being transmitted. The higher the SNR, the better the transmission of data in terms of high accuracy and long distance. Communications system with low SNR may not be suitable for automatic meter reading and other data transmission applications.

Furthermore, it is very difficult to develop a meaningful mathematical model for power line noise characteristics and adjust transmission compensators accordingly, because of little input resistance on low-voltage power line, high signal attenuation, complex disturbance, and randomness.

Another unique challenge of power line carrier communication systems is the method used to couple the communications signal onto the power network. In the receiver direction, it is desired that the coupling device possess a band-pass characteristic, blocking 60 Hz mains voltages, and passing signals at the carrier frequency. In the transmit direction, the coupler needs to possess high-pass properties, passing the communications signal unattenuated. Such a network should also be impedance matched to the power line for maximum power transfer. As devices are connected and disconnected from the power network, network characteristics change drastically. This makes coupling a signal to the power network difficult. Any coupling device must be adaptable to obtain reasonable performance in all expected situations.

### SUMMARY OF THE INVENTION

The invention increases the performance of two-way carrier wave digital data transmission between a terminal station and a central station over low-voltage power line at low implementation cost. In accordance with one embodiment of the present invention, this is done by utilizing −10 VDC, which is much higher than the threshold of most expected noise levels in the carrier signal (e.g., at around 1.5 VDC), as the triggering voltage pulse for a carrier signal at a frequency between 50 kHz and 75 kHz. The carrier signal is superimposed onto the 60 Hz line-to-neutral sinusoidal voltage waveform, with the triggering voltage introduced at the 160-degree phase angle for 10-15 microseconds. The triggering voltage signal pulse informs the transmitter if there is signal to be sent, or inform the receiver to detect if there is carrier signal arriving to be received. The interruption of the triggering voltage signal pulse at the 160-degree phase angle is introduced at the declining portion of the waveform (at about +40V level), near the zero crossing, and at the fundamental working frequency of the waveform. Consequently, as indicated in the prior art and verified in laboratory experiments, there is less noise interference and signal attenuation of the carrier signal at the zero crossing.

The transmitter generates the triggering voltage signal pulse by shorting the output circuit. This creates a high-energy pulse with little power consumption required of the transmitter power supply. At the receiver end, the receiver filters the transmitted signal at the 160-degree phase-angle of the carrier frequency for waveform above 3 VDC in order to isolate the signal from the noise level. The high signal-to-noise ratio of the invention allows the receiver to clearly differentiate the received data between a “1” bit and a “0” bit data in the carrier signal. Depending on the error tolerance level, the transmitter can also be placed further away, increasing the range of transmission. Since the interruption is done at the 40 VAC level near the zero crossing, and the time interval is very short, the superimposed signal does not compromise the power quality of the power distribution system. Further, by utilizing a low frequency carrier signal, between 50 kHz and 75 kHz, the distortion on the carrier signal is also reduced.

The transfer of data is bi-directional and half duplex between one hot wire and the neutral. Full duplex can be achieved by utilizing two sets of transreceivers: one set across the two wires between the hot wire and the common neutral; and the other set is across the other hotwire and the common neutral.

The invention can be implemented as an open system or as a protocol neutral medium, which means that it can be used in conjunction with any protocol and digital signal processor. By combining the invention with an error detection method, such as checksum or cyclical redundant checking, and an error correction method, such as forward error correction, this two-way carrier wave data transmission can then transmit and receive signals with extremely high accuracy at a much lower cost of implementation than currently available power line carrier technologies.

As a result, the coupling circuit is less complex than prior art couplers, thus simplifying the design of the transmitter and the receiver. The simplicity of the communication device and the increase in performance as indicated above translates to low cost of implementation. Consequently, this invention has been proven to be economically viable in the field of automatic meter reading.

### BRIEF DESCRIPTION OF THE DRAWINGS

FIG. 1 is an electric diagram illustrating a typical electric power distribution system.

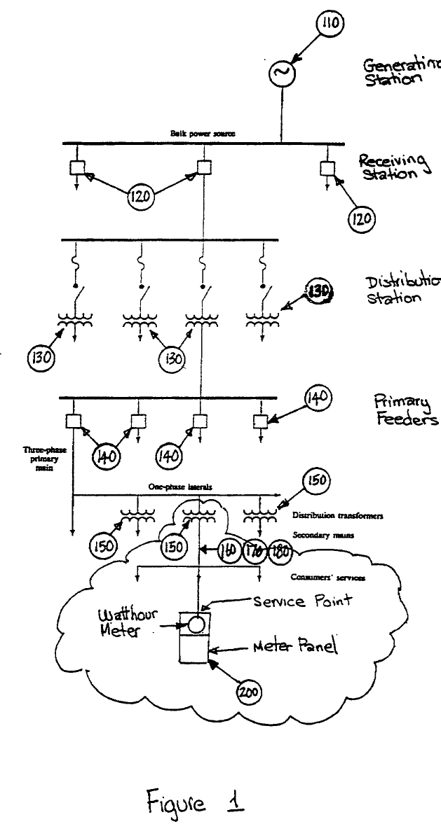

FIG. 2 is an electric diagram illustrating the electrical service feed from a distribution transformer to a meter service panel.

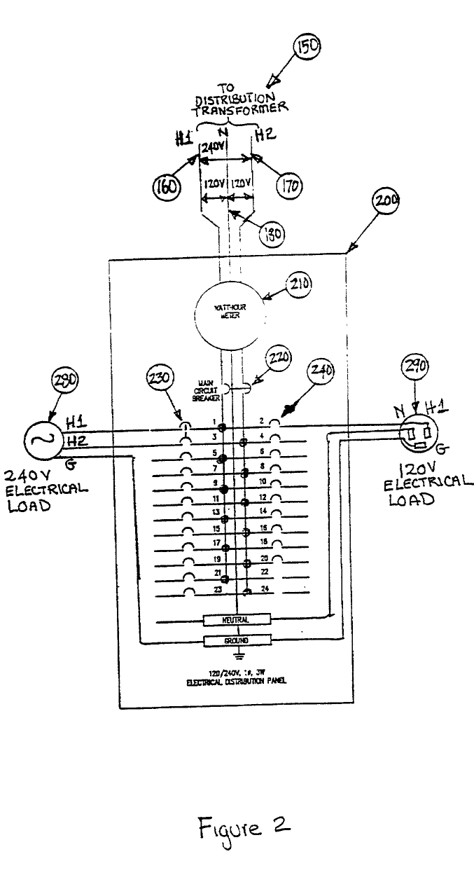

FIG. 3 is a waveform diagram showing how a sinusoidal wave is modulated using the frequency shift keying modulation method.

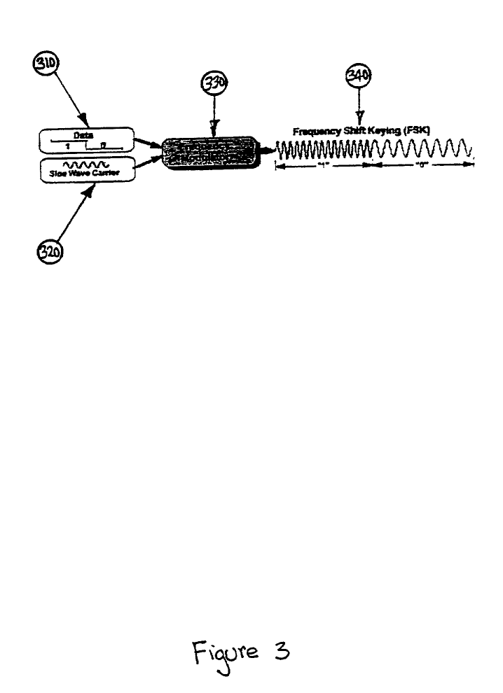

FIG. 4 is a waveform diagram illustrating where and to what amplitude is the interruption to the fundamental working frequency in order to generate the necessary carrier signal in accordance to one embodiment of the invention.

FIG. 5 is a circuit diagram of a transmitter circuit in accordance with one embodiment of the present invention.

FIG. 6 is a circuit diagram of a receiver circuit in accordance with one embodiment of the present invention.

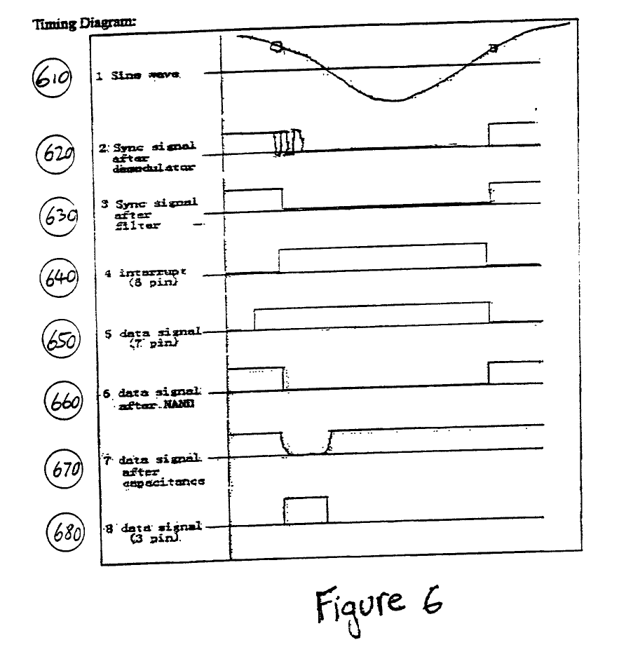

FIG. 7 is a circuit diagram of a transceiver showing the transmitter and receiver in accordance with one embodiment of the present invention.

FIG. 8 is a block diagram of a smart meter showing the transmitter, the receiver, and associated devices in accordance with one embodiment of the present invention.

FIG. 9 is a block diagram of a communication circuit consisting of smart meters, relay agents, and data collector in accordance with one embodiment of the present invention.

FIG. 10 is a circuit diagram illustrating how the invention can be used in home automation and load shedding.

### DETAILED DESCRIPTION OF ILLUSTRATED EMBODIMENTS

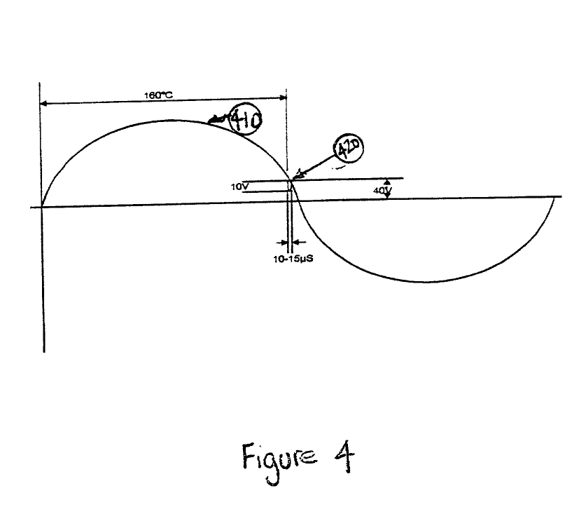

The invention overcomes the difficulties of high interference, high distortion and high attenuation by using the fundamental working frequency as the carrier frequency. As shown by FIG. 4, the −10 Vdc triggering/interrupt signal 420 in a carrier signal is superimposed on a 120 Vac, 60 Hz fundamental working frequency, alternating current sinusoidal voltage waveform 420 near the zero crossing at the 160-degree phase angle for 10-15 microseconds. This voltage level is much higher than the expected random noise signal, usually up to 1.5V, thus generating a high signal-to-noise ratio. As a result of the high signal-to-noise ratio, the receiver then can receive the transmitted signal and clearly differentiate between a “1” bit and a “0” bit data.

Further, since the interruption is done at the 40 VAC level near the zero crossing where there is less signal attenuation and little interference of periodic pulse cycle, the superimposed signal does not compromise the power quality of the power distribution system. Further, since distortion, which is a combination of different reactive load and line characteristics, occurs less frequently at low frequency, the invention also benefits with less distortion since the interrupt pulse 420 is at 60 Hz and the pulse signal is generated at a frequency between 50 kHz and 75 kHz, rather than in the hundreds of kilohertz range as characteristic with the prior art PLC communication systems. In each of the AC period, there are two peak values. Therefore, up to two bits of data can be transmitted per cycle or at a maximum speed of 120 bauds at one phase.

Transmitter

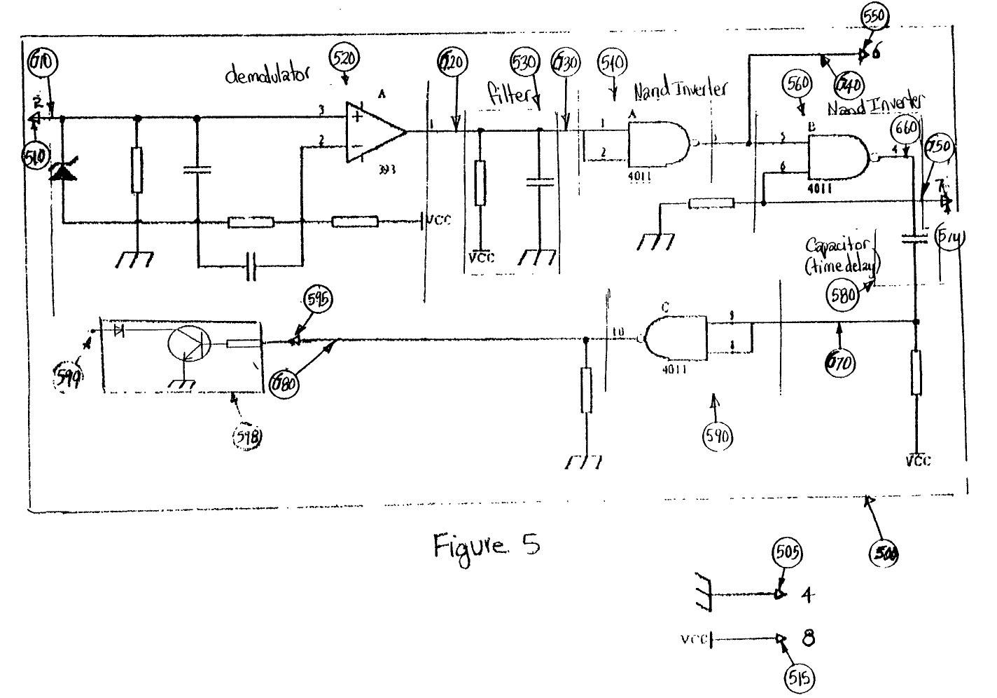

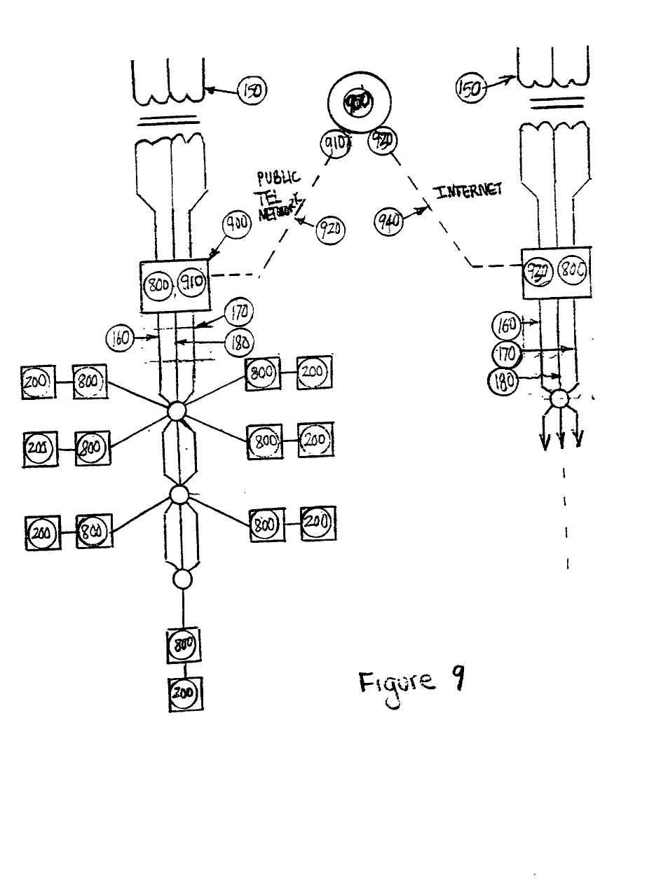

One embodiment of the invention is the transmitter circuit 500 shown in FIG. 5. The transmitter 500 is connected to the 120 VAC hot wire of the power line at terminal 510, and to the neutral wire at terminal 515. The interrupt signal is at terminal 505. The demodulator 520 monitors the fundamental power sine wave 610 in order to determine the synchronization signal 620 or the time when the sine wave reaches the 160-degree phase angle to allow data to be transferred. The precise phase angle is determined by the resistors and capacitors of the demodulator 520. The synchronization signal 620 is then passed through the filter 530 to remove excess noise, resulting in the square waveform output 630 with defined high and low signals. Square waveform 630 is then inverted via the NAND inverter 540 and becomes waveform 640. The waveform 640 is then forwarded to the external processor as an interrupt signal at 550. The data to be transmitted is sent to terminal 570. When the synchronization signal is positive, the data can then be transmitted through the NAND Inverter 560 resulting in waveform 660. The waveform 660 is then passed through the capacitor 570 to generate the desired final signal frequency resulting in waveform 670. The waveform is further inverted via the NAND inverter 590 in order to filter out the excess noise level and clearly define the “1” and “0” bits. With the right synchronization window at the 160-degree phase angle and a negative or “0” bit, the 10 VDC square waveform 680 is then superimposed on the power line via terminal 595. This is done via circuit 598. When there is a high voltage signal at 595, the 10 VDC hotline 599 from a power supply source is shorted to ground to create a pull-down pulse for the data signal. The resistor of circuit 598 and the capacitor 570 determine the frequency of the carrier signal, which can range from 50 kHz to 75 kHz. They also determine the interrupt/triggering signal pulse amplitude, which as in this case is around 10 VDC. Likewise, for a “1” bit, no voltage superposition is applied. The transmitter 500 may be located at or near a node in the low voltage power transmission network beyond the distribution transformer 150, such as incorporated in the smart meter 800 discussed below in connection with FIG. 9.

Receiver

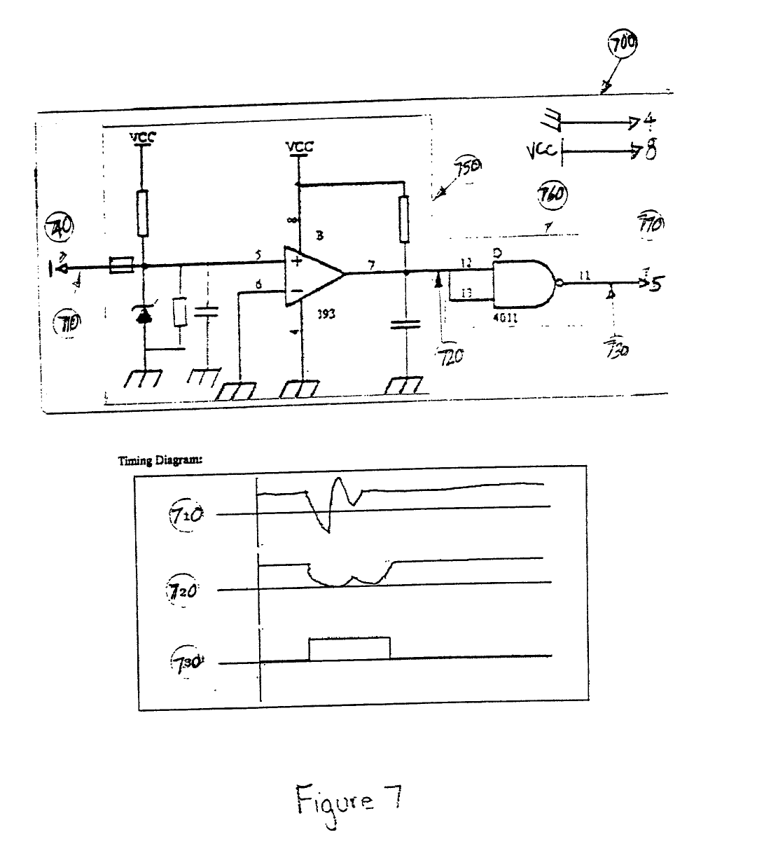

One embodiment of the invention is the receiver circuit 700 used to convert the analog input signal received from transmitter 500 into a digital signal as shown in FIG. 7. The sinusoidal input waveform 710, with the superimposed carrier signal, is transmitted to the carrier signal and power line-coupling end 740 of the receiver 700, and then through to the demodulation circuit 750. The demodulation circuit 750 filters the input waveform 710 for the positive cycle and amplifies the signal, resulting in the waveform 720. The resistors and capacitors of demodulation circuit 750 define the filter characteristics. In this case, the demodulation circuit 750 filters the transmitted signal for interruption/triggering signal, which has amplitude higher than 3 VDC, above practically most of the thresholds of noise levels, and at a frequency between 50 kHz and 75 kHz, which were previously determined and defined by the transmitter circuit 500. Waveform 720 is then sent through a NAND inverter 760 to become the square wave with clearly defined “1” and “0” digital signal 730. The square waveform 730 is then sent out of the receiving end 770 to a digital signal processor in order to translate the “1” and “0” bits into informational data. The phase angle of the carrier signal is synchronized with the interrupt signal of the transmitter with the aid of a processor and handshaking protocol. The receiver 700 may be located at or near a node in the low voltage power transmission network beyond the distribution transformer 150, such as incorporated in the smart meter 800 discussed below in connection with FIG. 9.

Transmission Process

Data transmission with the above transreceiver, containing the above-mentioned transmitter and receiver, can be implemented through various processes and protocols. One method of implementation can be as follows. In the transmission process, for example, data is loaded into the PLC transreceiver and it automatically waits for the channel to be idle, determines the message priority level so as to let higher priority messages go through first, detects and resolves medium contention, generates synchronizing characters, transmits the Start Of Packet character, adds error correction bits, calculates a checksum word or a Cyclic Redundancy Check word to detect errors, transmits the End Of Packet character, and finally appends the calculated CRC. The application controller feeds the PLC transreceiver with packet data, and the PLC transreceiver automatically facilitates communication functions.

The receiver processor writes incoming data to a buffer. After storing sufficient data, the processor examines the received packet fragment to determine the protocol in use and, if it recognizes the protocol, decodes the included destination address. For protocols unknown to the node and for destination addresses that do not match the node address, the processor issues an error message to the transmitter that subsequently halts data transfer to the host. Once authentication is achieved, receiving is straightforward: the receiver automatically performs the opposite functions. The detailed methods of implementation are up to the designer and programmer. The invention is the medium itself with its distinctive carrier signal method at the fundamental working frequency.

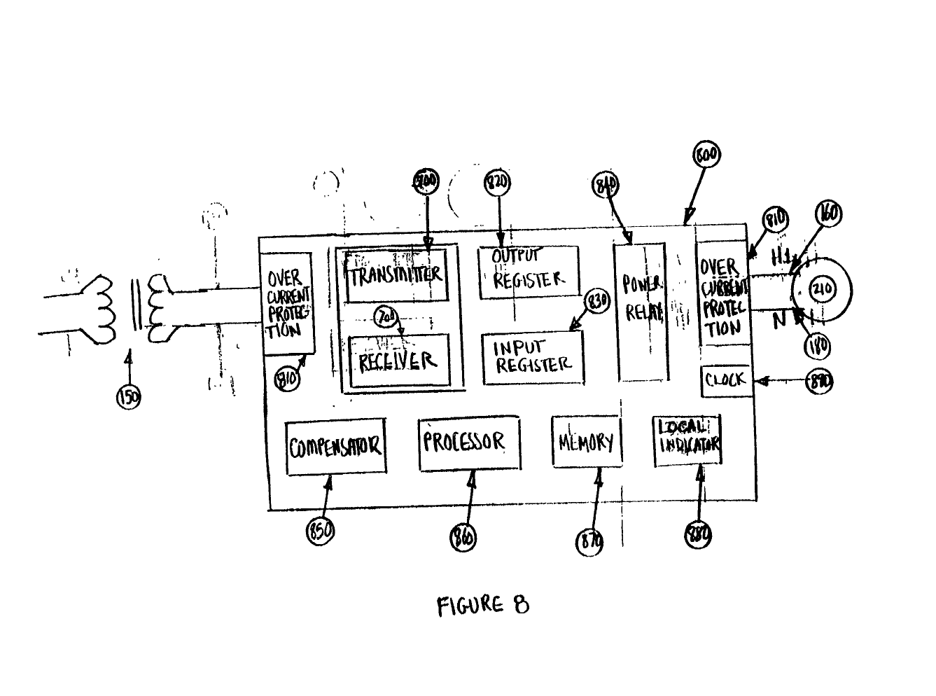

Further, the invention can also be applied with other auxiliary devices. As shown in FIG. 8, the smart meter 800 is installed between a distribution transformer 150 and the service meter panel 210. The smart meter 800 receives carrier signal from electrical wires 160 and 180. It can consist of an overcurrent protection device 810, which protects the circuit from surges and spikes, transmitter circuit 500, receiver circuit 700, input register 830, and output register 820. The circuit can have a compensator 850 to compensate for known noise or predictable disturbances on the line in order to improve the signal-to-noise ratio. Likewise, control algorithms can be stored in the processor 860 with appropriate identification tags, function codes, and polling or broadcasting sequences. Information is stored in memory 870. As a convenience to the consumer, a local indicator 880 can be provided to indicate the status of the connected devices. It can function as an interface device to see what the smart meter is actually is seeing. Power relay 840 can be utilized for load control such as load shedding during peak demand. A clock 890 is used for synchronization.

Applications

The invention may be utilized for remote real time meter reading and data analysis, load monitoring and control, home automation, illegal tap and theft of electrical power detection along the distribution line, fault location detection along a transmission line, transformer and line relay protection, and numerous other two-way coded communications functions.

One prime example is the field of automated meter reading where this invention has been proven to work. In the utility industry, it is common practice to charge each consumer in accordance with the amount of utility service such as electric energy, gas, water or the like used over a period of time by the consumer. Highly reliable meters have been developed to measure the amount of the commodity used by a consumer. These meters are located at the service point.

It is a conventional practice for utility meter readers to manually read the information on the meters at monthly intervals. These readings are then passed on to another department to determine the billing to the consumer. This process is labor intensive. The need for an automatic metering data acquisition system is well known in the utility industry.

One embodiment of the invention, as shown in FIG. 9, is to automate meter reading of all power flow going from the secondary side of the distribution transformer 150 through power wires 160, 170, and 180, to all service meter panels 200 serviced by that distribution transformer. Generally each service meter 200 represents a load on the distribution transformer 150. The individual consumer is charged for the power delivered over the service main. The smart meter 800 measures the power consumed and transmits real time data back to the relay agent 900 when queried. Each smart meter 800 has a distinct address, with defined function codes, data control and data storage capability. When queried for information, only one smart meter 800 can transmit a signal during a predefined time interval; likewise, the relay agent 900 can only receive one packet of data at one time.

The relay agent 900 is installed between the secondary side of the distribution transformer 150 and the first service meter panel 200 with its dedicated smart meter 800. It has the same transmit and receive capabilities as the smart meter 800. It also has the capability to collect data collectively or individually from all smart meters 800 and transmit the data further to the data collector 950 via a prescribed communication medium for signal processing.

Data collected by the relay agent 900 are then transferred to the data collector 950 by utilizing modems 910 for signal transmission over public telephone network 920, embedded communication module 930 over the Internet 940, or any other communication medium.

The data collector 950 then can record the transmitted information, analyze the data for abnormal conditions, monitor power transmission conditions, or perform any other forms of data processing and system control. The data collector 950 can query for further information or terminate communication.

In practical application of meter reading communication over low voltage power line, the invention has achieved successful digital data transmission rate above 97% without further processing, and up to 2 km in transmission distance with low load on the power line. When combined with an error detection method, such as checksum or cyclical redundant checking, and an error correction method, such as forward error correction, this two-way carrier wave data transmission can then transmit and receive signals with extremely high accuracy at a much lower cost than currently available power line carrier technologies.

With the ability to read the meters remotely, the power utility can also implement automatic load shedding. The desired system would allow utility companies to read all meters in a city at desired intervals, such as during daily peak power periods. The utility can then determine which load to be shed in order to improve the load factor of the system and avoid the collapse of the system such as a blackout. The utility can also alert the end consumer by the automatic activation of an indicator at the residence to reduce energy usage or at least become aware of an abnormal condition such as premium billing rate for usage during peak demand.

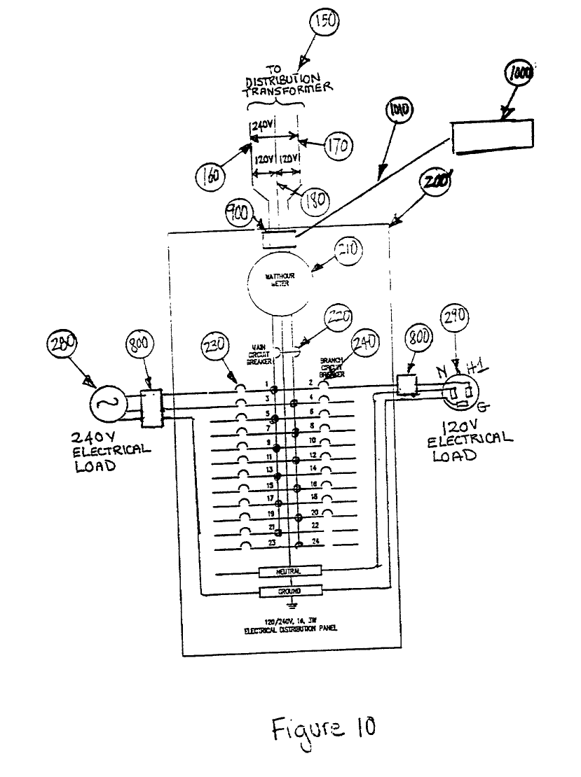

While the above example serves the need of the utility, the invention can also be applied by the end consumer to observe the status of devices such as intrusion alarm and gas detector; to monitor the power usage of appliances; and to control electrical loads via a controller and interposing relays such as automatically turning off clothes dryer during peak billing period. This application is prevalent in home automation, where it is necessary to communicate with smart appliances and control their function remotely. For example, as shown in FIG. 10, the controller 1000 can be used to monitor the status and power consumption of the various devices 280 and 290 connected to a meter panel 200′ and monitored by a relay agent 900 via communication line 1010 (e.g., the Internet or wire or wireless telephone network). The controller 1000 can be programmed to automatically turn off non-critical appliances at a predetermined time or when the billing cost is at peak level. The invention allows the consumer to manage domestic electrical load to minimize cost and maximize efficiency. As indicated by the application of this invention and utilizing the home's already existing power wires and network, the home automation process is facilitated.

While the present invention is described herein with reference to particular applications, it should be understood that the invention is not limited hereto. It will be apparent to those skilled in the art that various modifications and improvements may be made without departing from the scope and spirit of the invention. For example, the inventive concept herein may be applied to any power line system frequencies, such as 50 Hz fundamental frequency, and to any variations of the power line distribution secondary voltages, such as 220/380 VAC or 220/480 V, single phase or three phase, which are currently being utilized outside of the United States. It can be applied to any forms of meter reading and load control where the controller can be a field programmable gate array, digital signal processor, microprocessor, programmable logic controller, or another other electrical equipment with processing capability. It can be used to facilitate widespread distribution of Internet, intranet, cable TV, telephony and other communication systems. It can also be used in conjunction with other communication technologies such as signal repeaters, the public telephone network and the Internet to transmit data to any point the user deems necessary. The location of any of the digital signal can be placed locally and/or remotely via a network. Accordingly, it is to be understood that the invention is not to be limited by the specific illustrated embodiments, but only by the scope of the appended claims.

1. A method for digital data transmission in a low voltage AC power line network, comprising the steps of: transmitting a AC voltage waveform to deliver power in the power line network;
generating a carrier signal representing the digital data, said carrier signal superimposed on the AC voltage waveform;
introducing a triggering DC voltage having an amplitude that is higher than the threshold of the expected noise level in the carrier signal; and
receiving the carrier signal and determining from the carrier signal the digital data based on presence of the triggering voltage of the carrier signal.

2. A method as in claim 1, wherein the step of introducing the triggering DC voltage comprises the step of interrupting the output of the AC voltage waveform.

3. A method as in claim 2, wherein the step of interrupting the output of the AC voltage waveform comprises the step of shorting the AC voltage waveform momentarily.

4. A method as in claim 1, wherein the triggering DC voltage creates a momentary decrease in absolute voltage level in the AC voltage waveform.

5. A method as in claim 4, wherein the triggering DC voltage is introduced to the AC voltage waveform at a phase angle near the zero crossing of the AC voltage waveform.

6. A method as in claim 5, wherein the triggering DC voltage is introduced to the AC voltage waveform at about 160-degree phase angle.

7. A method as in claim 6, wherein the amplitude of the triggering DC voltage is at least about six times as large as the threshold of the expected noise level.

8. A method as in claim 7, wherein the amplitude of the triggering DC voltage is about 10 VDC and the expected threshold of the noise level is about 1.5 VDC.

9. A method as in claim 1, wherein:
the amplitude of the voltage waveform is about 120 VAC;
the amplitude of the triggering voltage signal is about 10 VDC;
the frequency of the carrier signal is between 50 kHz and 75 kHz;
the AC voltage waveform is about 60 Hz; and
the triggering voltage is at about 60 Hz, superimposed for 10-15 nanoseconds at a location along a declining portion of the AC voltage waveform where the magnitude of the AC voltage waveform is about the +40 VAC level.

10. A method for digital data transmission in a low voltage AC power line network, comprising the steps of:
transmitting a AC voltage waveform to deliver power in the power line network, said AC voltage waveform having a fundamental working frequency;
generating a carrier signal representing the digital data, said carrier signal superimposed on the AC voltage waveform;
introducing a triggering DC voltage at a frequency substantially similar to said fundamental working frequency; and
receiving the carrier signal and determining from the carrier signal the digital data.

11. A method as in claim 10, wherein the carrier signal is generated by interrupting the output of the AC voltage waveform.

12. A system for digital data transmission in a low voltage AC power line network, comprising:
means for transmitting a AC voltage waveform to deliver power in the power line network;
means for generating a carrier signal representing the digital data, said carrier signal superimposed on the AC voltage waveform;
means for introducing a triggering DC voltage having a amplitude that is higher than the threshold of the expected noise level in the carrier signal; and
means for receiving the carrier signal and determining from the carrier signal the digital data based on presence of the triggering voltage of the carrier signal.

13. A transmitter for transmitting digital data in a low voltage AC power line network in which a AC voltage waveform is transmitted to deliver power in the power line network, the transmitter comprising:
means for receiving the AC voltage waveform as an input;
means for generating a carrier signal representing the digital data, said carrier signal superimposed on the AC voltage waveform;
means for introducing a triggering DC voltage having a amplitude that is higher than the threshold of the expected noise level in the carrier signal; and
means for outputting the AC voltage waveform with the superimposed carrier signal.

14. A receiver for receiving digital data transmission in a low voltage AC power line network in which a AC voltage waveform is transmitted to deliver power in the power line network, the receiver comprising:
means for receiving a carrier signal representing the digital data, said carrier signal superimposed on the AC voltage waveform and having a triggering DC voltage having a amplitude that is higher than the threshold of the expected noise level in the carrier signal;
mean for detecting the triggering DC voltage; and
determining from the carrier signal the digital data based on presence of the triggering DC voltage of the carrier signal.

15. A method for digital data communication between a central station outside the low voltage power line network and a user station at a first node in the low voltage AC power line network, comprising the steps of:
communicating digital data between the central station and a relay agent at a second node in the low voltage AC power line network;
transmitting a AC voltage waveform in the power line network between the first and second nodes;
generating, at the first or second node, a carrier signal representing the digital data, said carrier signal superimposed on the AC voltage waveform;
introducing a triggering DC voltage having a amplitude that is higher than the threshold of the expected noise level in the carrier signal; and
receiving, at the respective second or first node, the carrier signal and determining from the carrier signal the digital data based on presence of the triggering voltage of the carrier signal.
